(19) United States
(12) Patent Application Publication
(10) Pub. No.: US 2005/0021502 A1
(43) Pub. Date: Jan. 27, 2005

(54) Data federation methods and system

(76) Inventors: Benjamin Chen, Carlsbad, CA (US); Jason Oliver, Los Angeles, CA (US); David Schwartz, Beverly Hills, CA (US); William Lindsey, Belmont, CA (US); Angus MacDonald, Los Altos, CA (US)

Correspondence Address: HELLER EHRMAN WHITE & MCAULIFFE LLP, 275 MIDDLEFIELD ROAD, MENLO PARK, CA, 94025-3506, US

(21) Appl. No.: 10/850,826

(22) Filed: May 20, 2004

Related U.S. Application Data
(60) Provisional application No. 60/473,354, filed on May 23, 2003.

(51) Int. Cl. G06F 17/30; G06F 7/00

(52) U.S. Cl. 707/2

(57) ABSTRACT

A method is provided for processing tree like data structures in a streaming manner. An initial context of name/value bindings is set up. A tree of objects is constructed. Each element in the tree of objects is represented as a function object that accepts a context parameter and a target parameter that it can send a stream of start, content, and end events to represent tree output. The parse tree of objects is examined for element names that are recognized as commands. The commands are converted to special function objects that implement command's semantics. Other elements, that are not recognized as commands, are mapped to a default function object.

### CROSS-REFERENCE TO RELATED APPLICATIONS

This application claims the benefit of U.S. Ser. No. 60/473,354, filed May 23, 2004, which application is fully incorporated herein by reference.

### FIELD OF THE INVENTION

The present invention is directed to Data Federation platform methods and systems, and more particularly to Data Federation platform methods and systems that help clients increase the efficiency, accuracy, and flexibility of their business processes and data management/data services, while reducing the risk, cost, and complexity associated with conventional solutions.

### DESCRIPTION OF THE RELATED ART

The importance of reducing the cost of doing business while increasing productivity, profitability, and agility has made Data Federation a ‘must have’ for Fortune-class companies. Initiatives, such as, customer care, risk management, supply-chain management, and multi-channel publishing—are based on successfully federating information from disparate data sources and making that data actionable.

Data Federation technology enables companies to access data for decision-intensive applications, when that data is distributed across multiple existing systems-such as, databases, applications, document repositories, flat files, mainframes, web services, and so forth. Until recently, any product attempting to address Data Federation inevitably was built on a highly proprietary, schema intensive meta-data structure. This meant a lot of time and energy expended on what became an essentially closed solution-not easily modified or adapted to suit an evolving business environment.

Data Federation is the ability to integrate different types of data—structured, semi-structured and unstructured, within and beyond an organization—, irrespective of the way that data is stored originally, regardless of static or streaming, and regardless of location, and then to make that data actionable within the organization.

Data Federation solves classes of problems that specifically involve decision-intensive, real-time issues—making support for live, streaming data from both structured and unstructured sources important. Often, Data Federation will look to leverage the existing investments of both the enterprise data warehouses and operational data stores by connecting and interoperating with those repositories.

Connecting multiple data sources in real time, Data Federation leaves data in the originating systems—accessing, transforming, and compositing the data when it is needed.

The most common way in which large enterprises solve Data Federation requirements today is through custom programming—patching existing Enterprise Application Integration (EAI) and Data Warehouse systems. These custom programs involve creating hard-coded logic between the presentation/portal layer and the back-end application/data sources. Other approaches may entail custom programming in mainframe, AS400, or other environments.

Often, the custom coding revolves around inserting data management normalization, business process logic, presentation logic, and composite object attributes and properties. The result of these solutions often follows months of pre-production work involving: 1) designing a master data schema to represent the union of the information in the disparate data sources; 2) designing a process to attempt to normalize the data internally; and then 3) creating a means with which to expose that composite data to portals, web pages, or other devices.

Enterprise Application Integration (EAI) has become the best practice for passing operational data between applications. EAI primarily has focused on providing secure, reliable connectivity between large corporate applications—for example, connecting accounting systems to HR to CRM systems. EAI vendors also provide portal and workflow solutions to overlay their connectivity and communications layers.

Data Federation leverages the enterprise's existing investment in EAI, where available, and plugs into the corporate workflow or portal architecture. Generally, it is in between the messaging and presentation layers of EAI that custom coding is done to solve the requirements for data federation.

Data Federation is not the same as Data Warehouses (DW) or Operational Data Stores (ODS). These approaches to data management have been successful at delivering a clean and consistent view into corporate data—albeit, an historical view. Data Federation delivers a real-time view into corporate data. The time and costs associated with first planning, designing, and implementing a DW or ODS and then physically aggregating data—through Extraction, Transform and Load tools (ETL)—into those stores is high; and the ability to change in response to new requirements is low. A Data Federation solution can be implemented much more quickly and be modified to adapt to changing business requirements easily.

To implement Data Federation, support for the capabilities listed below is required. Bidirectional access to data from multiple disparate sources in real time, which includes the abilities to deal with heterogeneous data sources from both within and outside the enterprise without having to move the data; handle both structured and unstructured (semi-structured) data formats including documents, flat files, and graphics; support both static and streaming data sources; provide bidirectional, transactional read, write, and updates to data sources; handle dynamic changes to data sources and data structures; and federate data to create composite business objects—that is, business objects that have contextual meaning to the end user (semantic business objects).

Federating data includes the following key characteristics: transforming complex data structures; mapping data multiple sources to a single composite object; inserting both data and business rules within the object; high performance execution engine; document/data repository; interfacing with existing business process flows; providing access control to individuals based on roles and groups; presenting composite objects to web pages, portals, WAP devices, SOAP services, and custom formatted data streams—that is, COBOL copy books.

XML is structured in the same way as HTML except that it is used more to describe data. It is not a programming language, but it is a set of rules or conventions that allow you to structure your data, making it easier for computers to generate and read data structuring data. XML is extensible, platform-independent, supports internationalization, and is fully Unicode-compliant.

XML (Extensible Markup Language) became widely adopted as a standard for data representation in the corporate world. So, now that XML is widely recognized as the standard way to represent data—both within and beyond the enterprise—, Data Federation is becoming a mainstream solution. It is XML's extensibility that makes it a very effective tool for normalizing the format of data interchange. This allows disparate systems to speak the same language without rewriting large amounts of code. Similarly, data from disparate sources can be combined and converted into an XML format so that multiple applications can access the data.

XML's power lies in its ability to capture hierarchical relationships, embed context, and allow precise control over information. However, the very attributes that make it so powerful also make it very difficult and expensive to process. For example, XML is extensible; therefore, application developers cannot assume a pre-defined, fixed structure. XML has achieved adoption as a corporate data standard and offers the following capabilities, a rich structure that allows hierarchical, tree-like representations of complex data structures; a self describing structure that includes tags with the data; extensibility; clear text that is human readable; unicode removes ambiguity and need for foreign language support; proliferation of toolsets from Microsoft, IBM, SUN, and others; native data support for Web Services, SOAP, and Microsoft .Net; and support for unstructured data sets that include databases, documents, graphics, and other content.

However, XML offers a number of challenges such as, it is processor and memory intensive to manipulate; it provides bulky representation of data due to inclusion of meta-data; and it is difficult to store in a relational database.

XML is an enabling technology for Data Federation. To take advantage of the benefits of XML, while overcoming the challenges, requires the following: an ability to normalize, index and cache XML data; the ability to federate XML fragments in a logical framework; and the ability to create semantic objects that allows access to XML data and makes that data actionable.

There is a need for improved methods for real time data federation. There is a further need for real-time data federation methods that create a design-time environment, a run-time environment, and a set of tools for monitoring and managing all aspects of a data federation solution. There is a further need for data federation methods that provide a virtual (coherent address space or namespace which addresses both a virtual and physical data repository), and can then be accessed seamlessly, and allows acquisition and unification of information from disparate sources for access through a consistent interface to include both users and systems. There is a further need for data federation methods with a parallel/pipeline processor and execution that have an ability to optimize tree based language execution based on environmental variables, including but not limited to the number of CPUs, memory, hard disk space, access to grid computing such services and the like. There is a need for data federation methods with reverse transformation capability for updating XML transformed XML content (to monitor for XSLT) and also combine a style sheet and source to get reversal.

### SUMMARY OF THE INVENTION

Accordingly, an object of the present invention is to provide improved methods for real-time data federation.

Another object of the present invention is to provide methods for real-time data federation that create a design-time environment, a run-time environment, and a set of tools for monitoring and managing all aspects of a data federation solution.

Yet another object of the present invention is to provide data federation platform methods that provide a virtual (coherent address space or namespace which addresses both a virtual and physical data repository), and can then be accessed seamlessly, and allows acquisition and unification of information from disparate sources for access through a consistent interface to include both users and systems.

Another object of the present invention is to provide data federation platform methods with a parallel/pipeline processor and execution that have an ability to optimize tree based language execution based on environmental variables, including but not limited to the number of CPUs, memory, hard disk space, access to grid computing such services and the like.

A further object of the present invention is to provide data federation platform methods with source code cache key capability, and because of tree based functional language creates an ability to cache the function results.

Yet another object of the present invention is to provide data federation platform methods with a mapper-tool for building style sheets capability that can build an optimized XSLT transformation tool.

Still another object of the present invention is to provide data federation platform methods using a runtime execution language that executes in a streaming fashion, specifically using an event parser/handler concept that can represent trees as streamed events.

Another object of the present invention is to provide data federation platform methods with bidirectional XML, including transaction, capability. (updating backend systems), and backpointer.

Yet another object of the present invention is to provide data federation platform methods with reverse transformation capability for updating XML transformed XML content (tp monitor for XSLT) and also combine a style sheet and source to get reversal.

Still another object of the present invention is to provide data federation platform methods with SOAP interceptor proxy technology, such as non-invasive id stamping of XML packets.

Yet another object of the present invention is to provide data federation platform methods that aggregate information from multiple sources, such as transaction environments, relational databases, documents, and other systems, and do not need to be stored locally.

These and other objects of the present invention are achieved in a method for optimizing distributed computing for tree like data structures represented via mark-up languages. An input is received. A determination is made to see if a plurality of execution process can be performed against the input. A determination is made to see if the input and the plurality of execution process can be split into components that can be run in parallel on different processors.

In another embodiment of the present invention, a method is provided for caching via lexical analysis. A parse tree is converted of a command to be executed to a character string representation is converted. Runtime parameters are converted used by the command to a character string representation of parameter names and values. Character strings are concatenated together. The character string is processed to generate a number. The number is looked up in an association table to determine if the number has been previously recorded. If the number is present, a value is returned that is associated with the number in the association table. The command is executed, the result is stored and the result is associated with the number in the association table before returning the result. The execution step retrieves, constructs, filters, and/or transforms tree like data structures.

In another embodiment of the present invention, a method is provided for optimizing a processing of template based transformation languages. A transformation script is parsed into logical templates. A node address expression is constructed for each template that specifies types of source nodes from tree like data structures that can be processed by that template. Other templates are identified that can cause that template to be invoked. The node address expression is modified by adding predicates that eliminate any source node type which is not available from the invoking templates. Each source node is examined against the types matched by each template.

In another embodiment of the present invention a method is provided for processing tree like data structures in a streaming manner. An initial context of name/value bindings is set up. A tree of objects is constructed. Each element in the tree of objects is represented as a function object that accepts a context parameter and a target parameter that it can send a stream of start, content, and end events to represent tree output. The parse tree of objects is examined for element names that are recognized as commands. The commands are converted to special function objects that implement command's semantics. Other elements, that are not recognized as commands, are mapped to a default function object.

In another embodiment of the present invention, a method is provided of reversing transformation of tree like data structures of the present invention is illustrated. First, a transformation script is transformed into a second script by replacing every command in the transformation script that copies a source leaf node to an output with a command that outputs a record of a source node's positional address and an output node's positional address. Second, an input source is transformed into a transformation script which produces a literal copy of the input source. Third, an input of the input source is transformed through the transformation script that is produced in the first step. Fourth, outputs from the second and third steps are transformed by replacing every command that constructs a leaf node with an appropriate node copying command for those nodes that were produced by copying.

In another embodiment of the present invention, a method for providing a non-repudiation audit trail receives a soap request through software. The soap request is audited by determining when the soap request was first seen and where it is from. A security step is performed to determine the person sending the soap request. A determination is made to see if a response requires transformation. This is followed by forwarding. Sending and receiving is performed to guarantee that a transaction was successful.

### BRIEF DESCRIPTION OF THE DRAWINGS

FIG. 1 is a schematic diagram of one embodiment of an architecture of a FDX system of the present invention

FIG. 2 is a flow chart illustrating one embodiment of the present invention with parallel/pipeline processing and execution with an ability to optimize tree based language based on environmental variables.

FIG. 3 is a flow chart illustrating one embodiment of the present invention with XRAP source code cache key capability, and because of tree based functional language creates an ability to cache the function results.

FIG. 4 is a flow chart illustrating one embodiment of the present invention with an XPath/Expression combiner (a mapper-tool for building style sheets capability) that can build an optimized XSLT transformation tool.

FIG. 5 is a flow chart illustrating one embodiment of the present invention with a runtime execution language that executes in a streaming fashion, specifically using a sax parser/handler concept that can be represented as streamed events.

FIG. 6 is a flow chart illustrating one embodiment of the present invention with reverse transformation capability for updating XML transformed XML content (tp monitor for XSLT) and also combine a style sheet and source to get reversal.

FIG. 7 is a flow chart illustrating one embodiment of the present invention with SOAP messaging non-repudiation capabilities.

### DETAILED DESCRIPTION OF THE PREFERRED EMBODIMENT

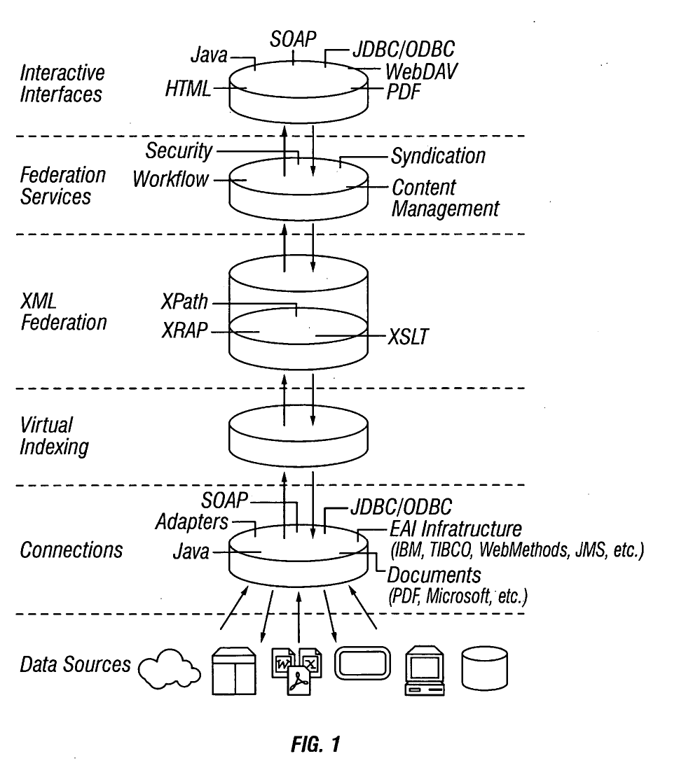

FIG. 1 is a high level schematic diagram of one embodiment of an architecture of the FDX system of the present invention.

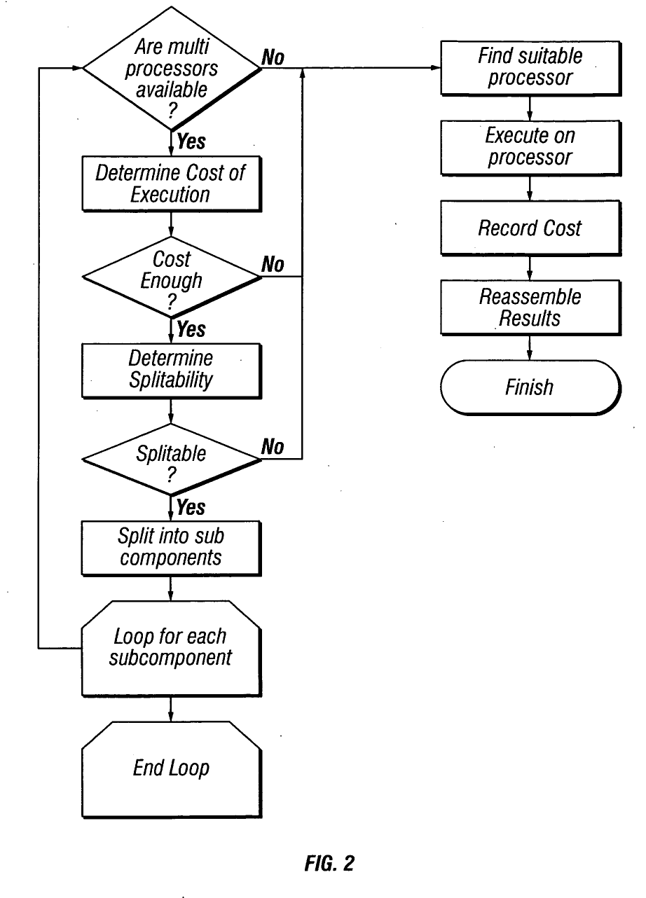

FIG. 2 illustrates one embodiment of the present invention for optimizing distributed computing for tree like data structures represented via mark-up languages. An input is received. A determination is made to see if a plurality of execution process can be performed against the input. A determination is made to see if the input and the plurality of execution process can be split into components that can be run in parallel on different processors.

The input is split into components A process is executed on each of the components with one or more processors to produce a plurality of results. The components are branches or nodes in the tree like data structures. The input includes anything that can be represented as a tree like data structure, including but not limited to XML, and the like. The mark-up languages can be anything that can be represented as a tree like data structure such as XML, and the like. A variety of different inputs can be utilized including but not limited to XML documents, soap web services, relational databases, flatfiles, and anything that can be represented as a tree like data structure. For purposes of this specification XML is defined as a subset of SGML that is completely described at (http://www.w3.org/TR/2004/REC-xml11-20040204/) Extensible Markup Language (XML) W3C Recommendation 4 Feb. 2004, edited in place 15 Apr. 2004, incorporated herein by reference.

A determination is made as to the cost of execution for the input. A determination is also made to see if executing the process modifies any data that is used in the step of processing of another component. A recordation is made in a memory, a file or in a database, of the cost in terms of computing resources for the step of executing the process. The recordation is in a memory, file, a database, and the like. The plurality of results are then reassembled into a new tree like data structure. A processing language is used that retrieves, constructs, filters and transforms the input. The processing language can be represented as XML. The processing language can have the same data model as the data itself. The processing language can include XML documents that are stored and manipulated in an XML database or computer file system.

In one embodiment, the processing language is built from atomic functions that can retrieve, construct, filter and/or transform tree like data structures which can be represented by XML and the like. The atomic functions are pipelined together to provide parsing, filtering and transformation of XML data sets.

Logic resources are provided for determining if the input and the plurality of execution process can be split into components that can be run in parallel on different processors.

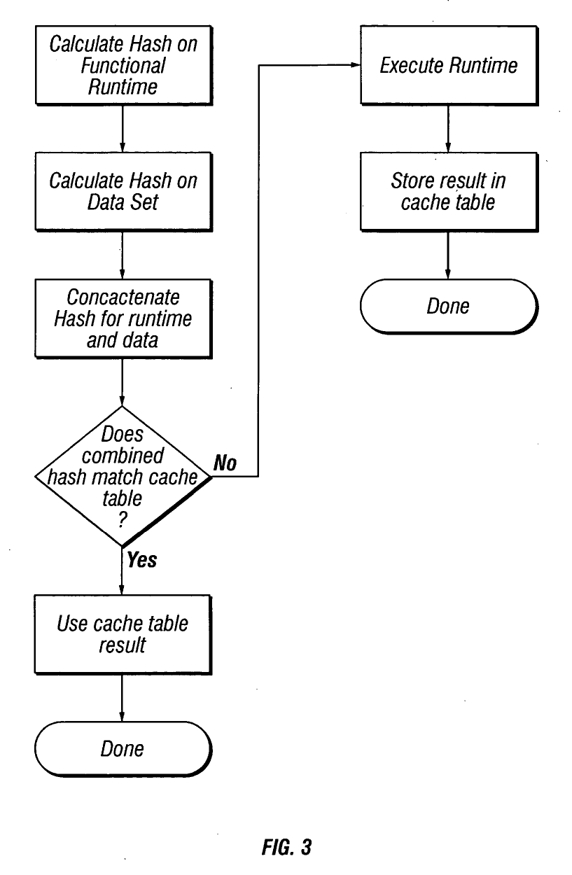

In another embodiment of the present invention, illustrated in FIG. 3, a method is provided for caching via lexical analysis. A parse tree is converted of a command to be executed to a character string representation is converted. Runtime parameters are converted used by the command to a character string representation of parameter names and values. Character strings are concatenated together. The character string is processed to generate a number. The number is looked up in an association table to determine if the number has been previously recorded. If the number is present, a value is returned that is associated with the number in the association table. The command is executed, the result is stored and the result is associated with the number in the association table before returning the result. The execution step retrieves, constructs, filters, and/or transforms tree like data structures.

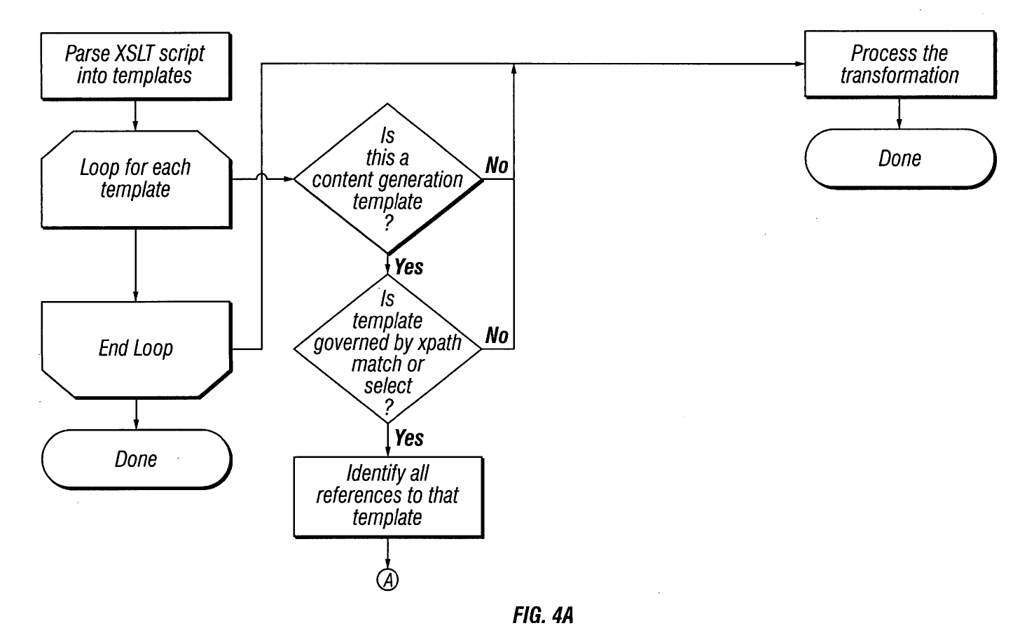

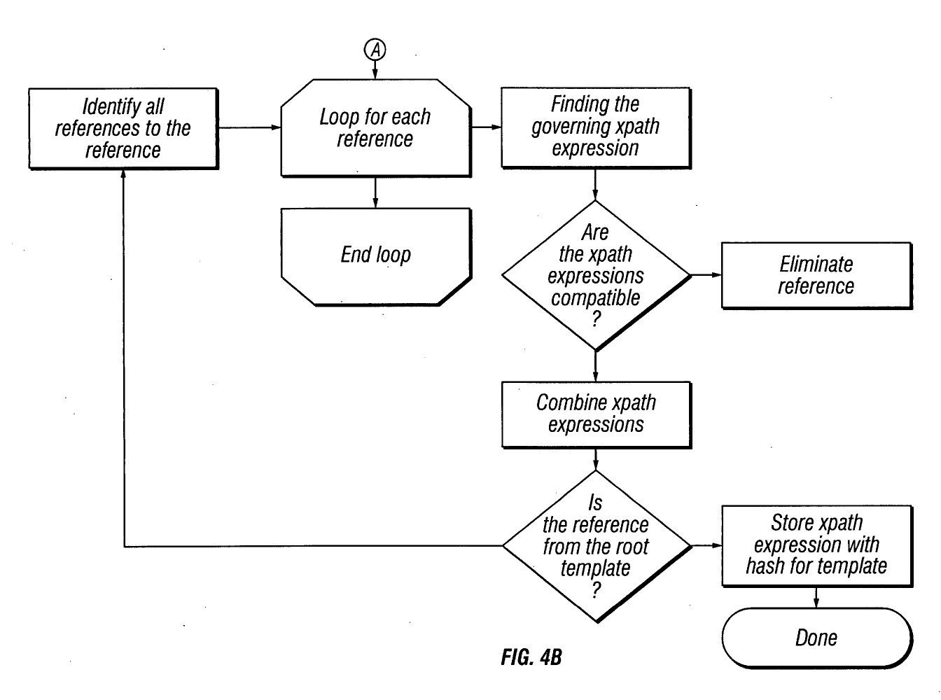

FIG. 4 illustrates an embodiment of the present invention that is a method for optimizing a processing of template based transformation languages. A transformation script is parsed into logical templates. A node address expression is constructed for each template that specifies types of source nodes from tree like data structures that can be processed by that template. Other templates are identified that can cause that template to be invoked. The node address expression is modified by adding predicates that eliminate any source node type which is not available from the invoking templates. Each source node is examined against the types matched by each template.

Constructing the node address includes extracting the node match parameter from the template. The step of identifying other templates includes, constructing a list all the templates, identifying each command in each template which invokes other templates, identifying the node address expression the invoking command uses to select the list of nodes it constructs before invoking the target template, and determining if the expression in the invoking command may address some of the same nodes as the target template.

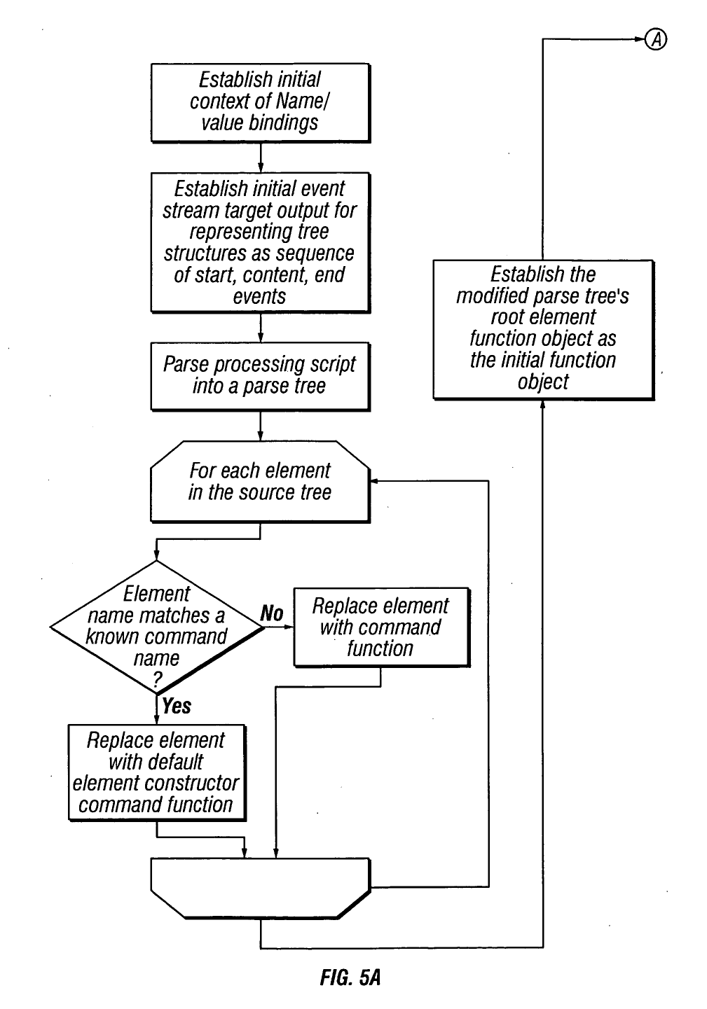

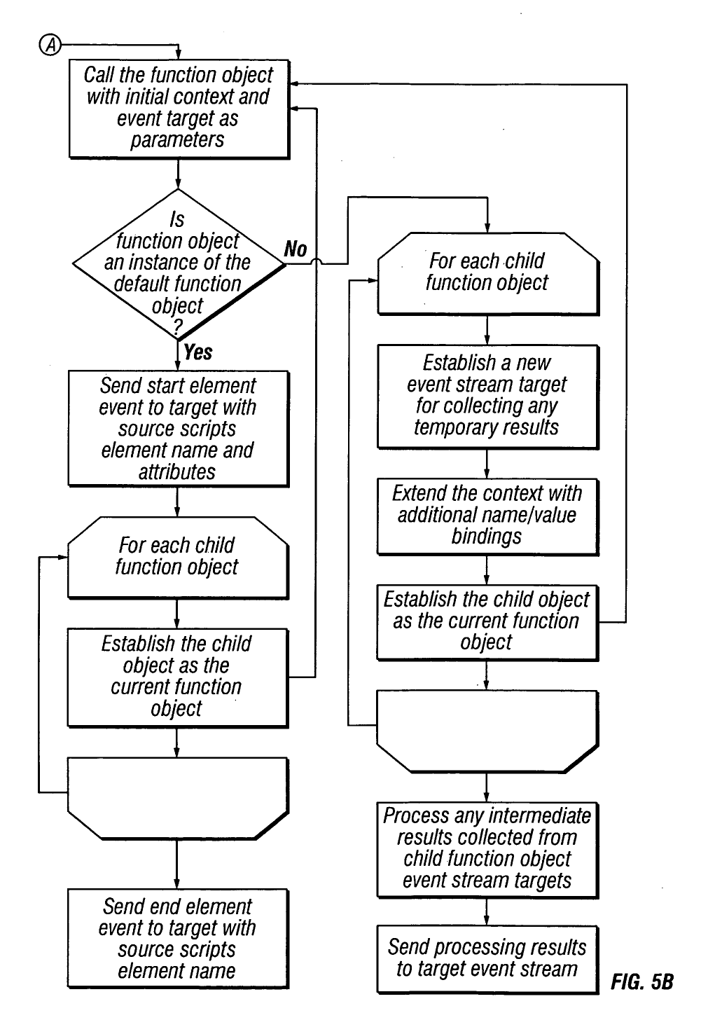

FIG. 5 illustrates an embodiment of the present invention of a method for processing tree like data structures in a streaming manner. An initial context of name/value bindings is set up. A tree of objects is constructed. Each element in the tree of objects is represented as a function object that accepts a context parameter and a target parameter that it can send a stream of start, content, and end events to represent tree output. The parse tree of objects is examined for element names that are recognized as commands. The commands are converted to special function objects that implement command's semantics. Other elements, that are not recognized as commands, are mapped to a default function object 301. The language used for processing is represented in tree like data structures such as XML

The default function object sends an event to a target parameter. The target parameter represents a start element with the same name as the parsed element, and calls the function of each child element with its original context and event target parameters.

The step of examining the parse tree of objects includes, identifying a root node of the tree, listing direct children of the node, for each child node in the list obtaining the node's element name property if available, and examining the node's list of children if available. The step of converting the commands includes, replacing the command object with a special function object at the same location in the tree. The step of mapping other elements includes replacing the other element object with the default function object at the same location in the tree.

Incoming data is analyzed. Pieces of the data are apportioned for processing. The data is inspected, leveraged, streamed and parsed. The parsed data is then executed in real time. Functional data processing language is used to provide that all commands return as a form of XML that is processed in optimized pieces. Downstream commands are utilized to generate results before a system command has finished.

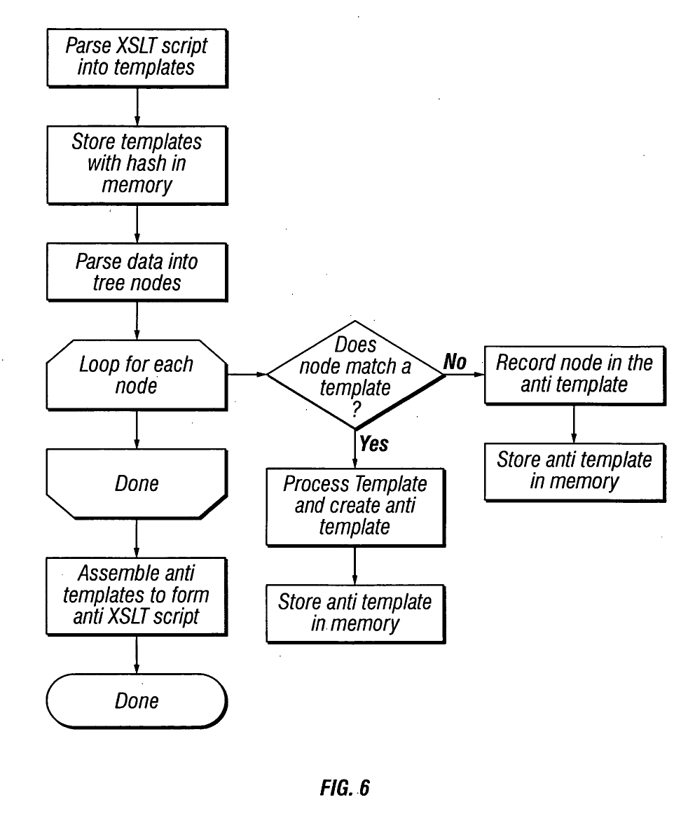

Referring now to FIG. 6, one embodiment of a method of reversing transformation of tree like data structures of the present invention is illustrated. First, a transformation script is transformed into a second script by replacing every command in the transformation script that copies a source leaf node to an output with a command that outputs a record of a source node's positional address and an output node's positional address. Second, an input source is transformed into a transformation script which produces a literal copy of the input source. Third, an input of the input source is transformed through the transformation script that is produced in the first step. Fourth, outputs from the second and third steps are transformed by replacing every command that constructs a leaf node with an appropriate node copying command for those nodes that were produced by copying.

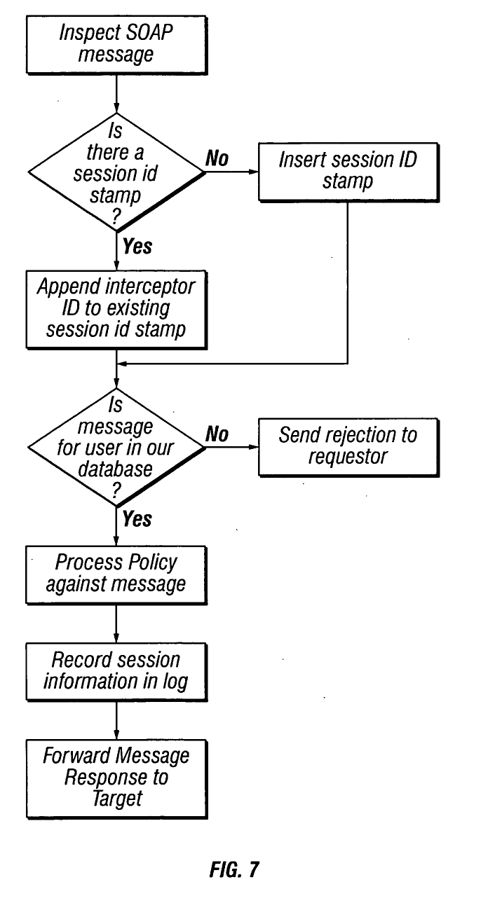

As illustrated in FIG. 7, one embodiment of the present invention is a method for providing a non-repudiation audit trail receives a soap request through software. The soap request is audited by determining when the soap request was first seen and where it is from. A security step is performed to determine the person sending the soap request. A determination is made to see if a response requires transformation. This is followed by forwarding. Sending and receiving is performed to guarantee that a transaction was successful.

The foregoing description of a preferred embodiment of the invention has been presented for purposes of illustration and description. It is not intended to be exhaustive or to limit the invention to the precise forms disclosed. Obviously, many modifications and variations will be apparent to practitioners skilled in this art. It is intended that the scope of the invention be defined by the following claims and their equivalents.

1. A method for optimizing distributed computing for tree like data structures represented via mark-up languages, comprising:
receiving an input;
determining if a plurality of execution process can be performed against the input;
determining if the input and the plurality of execution process can be split into components that can be run in parallel on different processors;
splitting the input into components;
executing a process on each of the components with one or more processors to produce a plurality of results,

2. The method of claim 1, further comprising:
determining if executing the process modifies any data that is used in the processing of another component.

3. The method of claim 1, further comprising:
recording in at least one of: a memory, a file or in a database the cost, in terms of computing resources, of the step of executing a process.

4. The method of claim 1, further comprising:
reassembling the plurality of results into a new tree like data structure.

5. The method of claim 1, wherein the input includes anything that can be represented as a tree like data structure.

6. The method of claim 1, wherein the input includes XML.

7. The method of claim 1, further comprising:
using a processing language that retrieves, constructs, filters and transforms the input.

8. The method of claim 7, wherein the processing language is represented as XML.

9. The method claim 1, further comprising:
wherein the processing language of has the same data model as the data itself.

10. The method of claim 1, wherein the processing language is built from atomic functions that can retrieve, construct, filter and/or transform tree like data structures.

11. The method of claim 10, wherein the processing language is built by retrieving, constructing, filtering and/or transforming tree like data structures represented by XML.

12. The method of claim 1, wherein atomic functions are pipelined together to provide parsing, filtering and transformation of XML data sets.

13. The method of claim 7, wherein the processing language includes XML documents that can be stored and manipulated in an XML database or computer file system.

14. The method of claim 1, wherein the mark-up language is anything that can be represented as a tree like data structure.

15. The method of claim 1, wherein the mark-up language is XML.

16. The method of claim 1, wherein logic resources for determining if the input and the plurality of execution process can be split into components that can be run in parallel on different processors.

17. The method of claim 1, wherein the inputs are selected from XML documents, soap web services, relational databases, flatfiles, and anything that can be represented as a tree like data structure.

18. The method of claim 1, further comprising:
determining a cost of execution for the input.

19. The method of claim 1, wherein the components are branches or nodes in the tree like data structures.

20. A method of caching via lexical analysis, comprising:
converting a parse tree of a command to be executed to a character string representation;
converting runtime parameters used by the command to a character string representation of parameter names and values;
concatenating character strings together;
processing the character string to generate a number;
looking up the number in an association table to determine if the number has been previously recorded;
returning a value associated with the number in the association table if the number is present;
executing the command and storing the result, and associating the result with the number in the association table before returning the result.

21. The method of claim 20, wherein the execution step retrieves, constructs, filters, and/or transforms tree like data structures.

22. A method of optimizing a processing of template based transformation languages, comprising:
parsing a transformation script into logical templates;
for each template constructing a node address expression that specifies types of source nodes from tree like data structures that can be processed by that template;
identifying other templates that can cause that template to be invoked;
modifying the node address expression by adding predicates that eliminate any source node type which is not available from the invoking templates.
examining each source node against the types matched by each template

23. The method of claim 22, wherein constructing the node address includes extracting the node match parameter from the template.

24. The method of claim 22, wherein the step of identifying other templates includes:
constructing a list all the templates;
identifying each command in each template which invokes other templates;
identifying the node address expression the invoking command uses to select the list of nodes it constructs before invoking the target template; and
determining if the expression in the invoking command may address some of the same nodes as the target template.

25. A method for processing tree like data structures in a streaming manner, comprising:
setting up an initial context of name/value bindings
constructing a tree of objects, each element in the tree of objects being represented as a function object that accepts a context parameter and a target parameter it can send a stream of start, content, and end events to represent tree output
examining the parse tree of objects for element names that are recognized as commands;
converting the commands to special function objects that implement command's semantics.
mapping other elements not recognized as commands to a default function object.

26. The method of claim 25, wherein the default function object sends an event to a target parameter.

27. The method of claim 26, wherein the target parameter represents a start element with the same name as the parsed element and calls the function of each child element with its original context and event target parameters.

28. The method of claim 25, wherein the step of examining the parse tree of objects includes:
identifying a root node of the tree;
listing direct children of the node; and
for each child node in the list,
obtaining the node's element name property if available; and
examine the node's list of children if available.

29. The method of claim 25, wherein the step of converting the commands includes:
replacing the command object with a special function object at a same location in the tree.

30. The method of claim 25, wherein the step of mapping other elements includes:
replacing the other element object with the default function object at the same location in the tree.

31. The method of claim 25, further comprising:
analyzing incoming data and apportioning pieces of the data for processing.

32. The method of claim 31, further comprising:
inspecting the data.

33. The method of claim 32, further comprising:
parsing the data and executing parsed data in real time.

34. The method of claim 33, further comprising:
leveraging, streaming and parsing the data.

35. The method of claim 34, further comprising:
using functional data processing language to provide that all commands return as a form of XML that is processed in optimized pieces.

36. The method of claim 35, further comprising:
utilizing downstream commands to generate results before a system command has finished.

37. The method of claim 25, wherein the language is for processing tree like data structures.

38. The method of claim 25, wherein the language is represented in XML 3.

39. A method of reversing transformation of tree like data structures, comprising:
(1) transforming a transformation script into a second script by replacing every command in the transformation script that copies a source leaf node to an output with a command that outputs a record of a source node's positional address and an output node's positional address;
(2) transform an input source into a transformation script which produces a literal copy of the input source;
(3) transforming an input of the input source through the transformation script produced in step 1; and
(4) transforming outputs of steps 2 and 3 by replacing every command that constructs a leaf node with an appropriate node copying command for those nodes that were produced by copying.

40. A method for providing a non-repudiation audit trail, comprising:
receiving a soap request through software;
auditing the soap request by determining when the soap request was first seen and where it is from;
performing a security step to determine the person sending the soap request;
determining if a response requires transformation; and
forwarding.

41. The method of claim 40, wherein sending and receiving is performed to guarantee that a transaction was successful.
